(19) United States
(12) Patent Application Publication
(10) Pub. No.: US 2005/0224058 A1
(43) Pub. Date: Oct. 13, 2005

(54) Device for reduction of exhaust gas and fuel economy for an internal-combustion engine

(76) Inventor: Sung Mo Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 10/520,906

(22) PCT Filed: Nov. 12, 2002
(86) PCT No.: PCT/KR02/02111

§ 371 Date: Mar. 7, 2005

(30) Foreign Application Priority Data
Jul. 9, 2002 (KR) 2002- 39706
Sep. 18, 2002 (KR) 2002-56941

(51) Int. Cl. F02M 27/00

(52) U.S. Cl. 123/538

(57) ABSTRACT

The present invention provides a device for reduction of exhaust gas and fuel economy which comprises a pair of diffusion fans (17, 18), a plurality of permanent magnets (8, 9, 11, 12) and metallic balls (13, 15) to cause the complete combustion of the fuel by its repeated diffusion and turning into particulates. According to the present invention, by complete combustion of the fuel, fuel economy and power otuput of an engine can be significantly enhanced and the exhaust gas can be considerably reduced.

### FIELD OF THE INVENTION

The present invention relates to a device for reduction of exhaust gas and fuel economy for an internal-combustion engine. More particularly, the present invention relates to a device for reduction of exhaust gas and fuel economy, which is mounted on a fuel supply line of an internal-combustion engine to compress and diffuse fuel and also to make molecules of the fuel particulates, thus resulting in complete combustion of the fuel.

### BACKGROUND OF THE INVENTION

Generally, fuel-air mixture is supplied to an internal combustion engine of vehicles such as automobiles and ships, and it has been required that the mixture be precisely controlled to satisfy the needs of reduction of exhaust gas, fuel economy, and the increase of power output.

A fuel injector applied to an internal-combustion engine electrically detects the amount of air intake and then injects fuel depending on the detected amount of air intake and conditions of operation of the engine. For this purpose, the fuel injector includes a control unit.

The injector injects fuel into an intake manifold of each cylinder according to signals received from the control unit, and comprises solenoid coil, a plunger and a needle valve. When current flows into the solenoid coil, the plunger is drawn and the needle valve integrally formed with the plunger is pulled such that an injecting nozzle is opened to inject the fuel.

The amount of the injected fuel depends on the time when the needle valve is open, i.e., the time during which current flows in the solenoid coil.

An electric circuit which controls the injector is largely divided into a voltage controlled circuit and a current controlled circuit, depending on whether a resistor is used.

In the meantime, a fuel economizer which raises swirl of the fuel injected from the injector is mounted on an inlet portion of the engine, and various forms of the fuel economizer have been known.

The fuel injected from the injector raises swirl in a combustion chamber while passing through the fuel economizer, and so-called “lean burn” which means that mixture ratio, in other words the fuel-air mixture becomes diluted is caused in the vicinity of an ignition plug, and accordingly the increase of the power output and the fuel economy effects can be achieved by the complete combustion.

However, although such a conventional fuel economizer caused the fuel economy effect due to the complete combustion and the simultaneous explosive power stroke resulted from the lean burn, since the swirl was not so strong and could not change the nature of the fuel itself, the fuel economy effect could not be obtained as much as expected.

### SUMMARY OF THE INVENTION

The present invention substantially obviates one or more of the problems encountered due to limitations and disadvantages of the prior art.

The object of the present invention is to provide a device for reduction of exhaust gas and fuel economy for an engine, which comprises a pair of diffusion fans, a plurality of permanent magnets and metallic balls to cause the complete combustion of the fuel by its repeated diffusion and turning into particulates.

Another object of the present invention is to provide a device for reduction of exhaust gas and fuel economy, which can reduce the amount of exhaust gas and simultaneously improve the power output of the engine by the complete combustion of fuel.

To achieve these objects and other advantages of the present invention, the device for reduction of exhaust gas and fuel economy according to the present invention comprises:
an inlet housing connected to a fuel pipe of a fuel tank; a first permanent magnet fitted in the inlet housing and having a hole in the center thereof; an outlet housing coupled with the inlet housing by coupling means at one end and connected to a fuel pipe to an engine at the other end; a second permanent magnet fitted in the outlet housing to have the same pole opposing the first permanent magnet and having a hole in the center thereof; a partition located between the housings to separate them and having a hole for passing the fuel in the central thereof; a third permanent magnet mounted on one side of the partition and having a hole in the center thereof; a fourth permanent magnet mounted on the other side of the partition and having a hole in the center thereof; a first ball inserted in the hole of the fourth permanent magnet and moving back and forth to turn the fuel into particulates; a sleeve mounted on the other side of the partition and having a hole for passing the fuel in the center thereof; a second ball inserted in the hole for passing the fuel of the sleeve and moving back and forth by magnetic force of the fourth permanent magnet, to turn the fuel into particulates; a cap mounted on one side of the sleeve and having a hole for passing the fuel in the center thereof and a plurality of fuel supply holes in its periphery to supply the fuel to a combustion chamber when the hole for passing the fuel of the sleeve is opened by stepping on an accelerator; a first diffusion fan mounted in the inlet housing to diffuse the fuel; and a second diffusion fan mounted in the outlet housing to further diffuse the fuel.

### BRIEF DESCRIPTION OF THE DRAWINGS

The accompanying drawings, which are included to provide a further understanding of the invention and are incorporated in and constitute a part of this specification, illustrate an embodiment of the invention and together with the description serve to explain the principles of the invention, wherein:

FIG. 1 is a disassembled perspective view of the device according to the present invention.

FIGS. 2a and 2b are vertical sectional views of FIG. 1 in an assembled state, wherein FIG. 2a shows the state of the device according to the present invention without stepping on an accelerator, and FIG. 2b shows the state with stepping on the accelerator.

FIG. 3 is a sectional view along the line A-A in FIG. 2a.

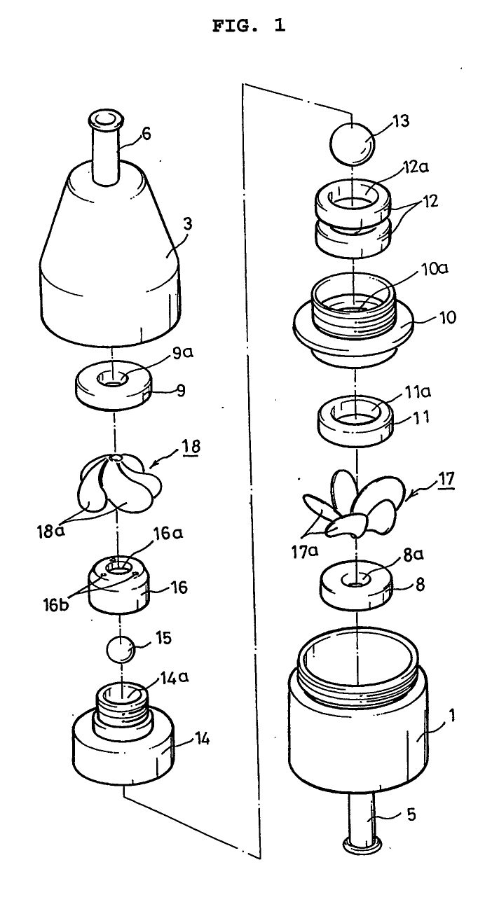

### DETAILED DESCRIPTION OF THE PREFERRED EMBODIMENTS

According to the present invention, the device for reduction of exhaust gas and fuel economy comprises:
an inlet housing (1) connected to a fuel pipe (2) of a fuel tank; a first permanent magnet (8) fitted in the inlet housing (1) and having a hole (8a) in the center thereof; an outlet housing (3) coupled with the inlet housing (1) by coupling means at one end and connected to a fuel pipe (4) to an engine at the other end; a second permanent magnet (9) fitted in the outlet housing (3) to have the same pole opposing the first permanent magnet (8) and having a hole (9a) in the center thereof; a partition (10) located between the housings (1 and 3) to separate them and having a hole for passing the fuel (10a) in the central thereof; a third permanent magnet (11) mounted on one side of the partition (10) and having a hole (11a) in the center thereof; a fourth permanent magnet (12) mounted on the other side of the partition (10) and having a hole (12a) in the center thereof; a first ball (13) inserted in the hole (12a) of the fourth permanent magnet (12) and moving back and forth to turn the fuel into particulates; a sleeve (14) mounted on the other side of the partition (10) and having a hole for passing the fuel (14a) in the center thereof; a second ball (15) inserted in the hole for passing the fuel (14a) of the sleeve (14) and moving back and forth by magnetic force of the fourth permanent magnet (12) to turn the fuel into particulates; a cap (16) mounted on one side of the sleeve (14) and having a hole for passing the fuel (16a) in the center thereof and a plurality of fuel supply holes (16b) in its periphery to supply the fuel to a combustion chamber when the hole for passing the fuel (14a) of the sleeve (14) is opened by stepping on an accelerator; a first diffusion fan (17) mounted in the inlet housing (1) to diffuse the fuel; and a second diffusion fan (18) mounted in the outlet housing (3) to further diffuse the fuel.

More specifically, the fuel pipe (2) of the fuel tank is connected to the inlet housing (1), and the inlet housing (1) is coupled with one end of the outlet housing (3) by coupling means, which in turn is connected to the fuel pipe (4) of the engine at the other end thereof. To connect each of the fuel pipes (2 and 4) with each of the corresponding housings (1 and 3), a nipple (5 or 6) can be formed integrally with the housing (1 or 3) or can be formed separately from the housing (1 or 3) to be coupled by screw.

According to an embodiment of the present invention, in order to connect the housings (1 and 3), a male screw (1a) and a female screw (3a) are used as the coupling means, and an O-ring (7) is inserted in the site of coupling the housings (1 and 3) to secure tightness.

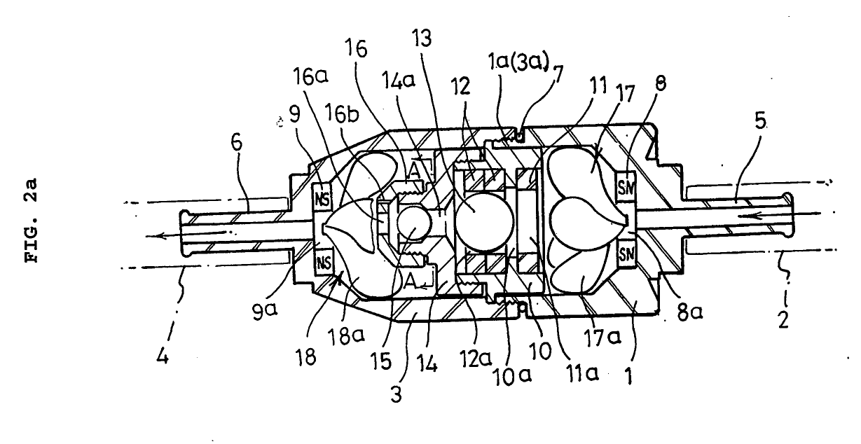

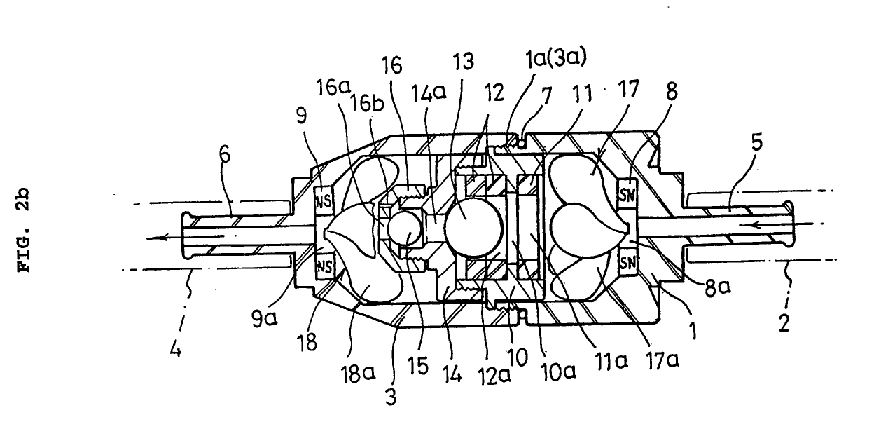

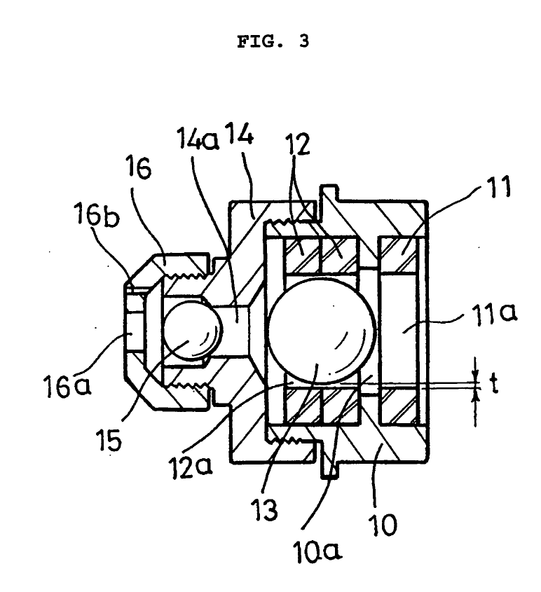

The first permanent magnet (8) is fitted into the inlet housing (1) and has the hole (8a) at the center thereof, and the second permanent magnet (9) is fitted into the outlet housing (3) and also has the hole (9a) in the center thereof. The second permanent magnet (9) is arranged in the outlet housing (3) such that its one pole may have the same polarity as the opposing pole of the first permanent magnet (8), as shown in FIGS. 2a and 2b.

The partition (10) is placed between the two housings (1 and 3) to divide the inside of the housings (1 and 3) and includes the hole for passing the fuel (10a) formed in the center thereof.

Also, on one side of the partition (10) into which the fuel enters, the third permanent magnet (11) having the hole (11a) in the center thereof is arranged in such a manner that its one pole may have the same polarity as an opposing pole of the first permanent magnet (8). On the other side of the partition (10) from which the fuel goes out, the fourth permanent magnet (12) having the hole (12a) in the center thereof is provided in such a manner that its one pole may have the same polarity as an opposing pole of the second permanent magnet (9).

The first ball (13) made of metallic material (magnetic material) is inserted into the hole (12a) of the fourth permanent magnet (12) to keep a predetermined interval (t) with the hole (12a). The first ball (13) is to supply the fuel of a predetermined quantity to the combustion chamber by turning the fuel into particulates. It is preferable that the interval (t) is about 0.05 to 1.0 mm.

If the interval is less than about 0.05 mm, the fuel cannot be sufficiently supplied, so that the fuel pump will be overloaded and impaired. To the contrary, if the interval is more than about 1.0 mm, turning of the fuel into particulates will be limited, and it will result in low efficiency.

Preferably, gauss (A) of the fourth permanent magnet (12) should be set to have larger gauss than the third permanent magnet (11). This is to maintain the first ball (13) inside the hole (12a).

For this purpose, according to the embodiment of the present invention, the fourth permanent magnet (12) is composed of two permanent magnets having the same gauss. However, the invention is not necessarily limited to the embodiment.

This is because, although the first ball (13) had been placed in the hole (11a) of the third permanent magnet (11) before starting an engine, when the fuel pump is driven by starting the engine, the first ball (13) moves towards the hole (12a) of the fourth permanent magnet (12) by the pumping force of the fuel.

One end of the sleeve (14) having the hole for passing the fuel (14a) in the center thereof is coupled with the other end of the partition (10) by screw. Inside the hole for passing the fuel (14a) of the sleeve (14), the second ball (15) is provided. The second ball (15) moves back and forth by the magnetic force of the fourth permanent magnet (12) to open and close the hole for passing the fuel (14a). The other end of the sleeve (14) is coupled with the cap (16) by screw. The cap (16) includes the hole for passing the fuel (16a) in the center thereof and a plurality of fuel supply holes (16b) in the periphery thereof.

As described above, when the first ball (13) made of metallic material is arranged in the hole (12a) of the fourth permanent magnet (12), the magnetic force flowing in the hole (12a) keeps the first ball (13) at a predetermined interval from the hole (12a).

In addition, inside the inlet housing (1), the first diffusion fan (17) is provided to diffuse the fuel injected by the driving of the fuel pump, and inside the outlet housing (3), the second diffusion fan (18) is provided to further diffuse the fuel.

The first and the second diffusion fans (17 and 18) respectively have a plurality of diffusion wings (17a and 18a) in the form of propellers and they are arranged to symmetrically oppose each other, so that the fuel can collide against the diffusion wings (17a and 18a) to form swirl and to be turned into particulates.

The diffusion wings (17a and 18a) are connected to the inner walls of the inlet housing (1) and the outlet housing (3), respectively, in order to maximize the diffusion of the fuel in the inlet and outlet housings (1 and 3) while the fuel is colliding against the diffusion wings (17a and 18a).

The operation of the device according to the present invention will be described.

When the device for reduction of exhaust gas and fuel economy of the present invention is installed in the fuel supply line of an automobile, the second ball (15) closes the hole for passing the fuel (14a) of the sleeve (14) due to the magnetic force of the fourth permanent magnet (12) as shown in FIG. 2a.

Then, if the fuel pump is driven by starting the engine, the fuel is introduced into the inlet housing (1) by the pumping force of the fuel pump. Then, the fuel passes through the hole (8a) formed in the center of the first permanent magnet (8) and collides against the diffusion wings (17a) of the first diffusion fan (17). The fuel which has been diffused by the diffusion wings (17a) passes through a gap having the interval (t) formed between the hole (12a) of the fourth permanent magnet (12) and the first ball (13), and is turned into particulates.

When the fuel passing the gap between the hole (12a) and the first ball (13) reaches the hole for passing the fuel (14a) of the sleeve (14), the second ball (15) which has been closing the hole for passing the fuel (14a) by the magnetic force of the fourth permanent magnet (12) as mentioned above, moves from the hole for passing the fuel (14a) by the pumping force of the fuel to form a gap, through which the fuel further turns into particulates. The particulate fuel is then supplied to the outlet housing (3) by passing the hole for passing the fuel (16a) and the fuel supply holes (16b) of the cap (16). Finally, the second diffusion fan (18) further diffuses the fuel in the outlet housing (3), and thus the combustion chamber can conduct the complete combustion of the fuel.

The above description explains the state of idling before the driver steps on an accelerator.

When the driver steps on the accelerator, the first ball (13) which has been inside the hole (12a) of the fourth permanent magnet (12) moves in the direction of supply of the fuel as shown in FIG. 2b, due to the pressure difference generated by the pressure of the fuel pump, and pushes the second ball (15) which has been closing the hole for passing the fuel (14a) of the sleeve (14), so that the hole for passing the fuel (14a) can be opened and simultaneously the hole for passing the fuel (16a) of the cap (16) can be closed. By the closing of the hole for passing the fuel (16a), the cross sectional area through which the fuel passes is decreased, but the pumping pressure of the fuel becomes increased, and thus the fuel is rapidly supplied to the combustion chamber through a plurality of the fuel supply holes (16b). More fuel can be supplied to the combustion chamber in the same period of time than in the state of idling where the driver is not stepping on an accelerator.

Finally, the diffusion wings (18a) of the diffusion fan (18) further diffuse the fuel, and thus it becomes possible to combust the fuel completely in the combustion chamber.

The present invention has various advantages compared to conventional fuel economizers.

Firstly, by the complete combustion of the fuel, a significant amount of fuel can be saved and a remarkable effect of fuel economy can be achieved.

According to the test using the device for fuel economy of the present invention, an automobile was driven at the speed of 80 Km/hr using and without using the device of the present invention, and the fuel consumptions under both conditions were measured and compared. The test result showed the fuel economy effect of 15% to 20% when using the device of the present invention.

Secondly, by the complete combustion of the fuel, the output power becomes significantly increased and it becomes possible to reduce the noise and vibration.

Thirdly, by the complete combustion of the fuel, generation of exhaust gas can be minimized and it can prevent atmospheric contamination.

1. A device for reduction of exhaust gas and fuel economy comprising:
an inlet housing connected to a fuel pipe of a fuel tank; a first permanent magnet fitted in the inlet housing and having a hole in the center thereof; an outlet housing coupled with the inlet housing by coupling means at one end and connected to a fuel pipe to an engine at the other end; a second permanent magnet fitted in the outlet housing to have the same pole opposing the first permanent magnet and having a hole in the center thereof; a partition located between the housings to separate them and having a hole for passing the fuel in the central thereof; a third permanent magnet mounted on one side of the partition and having a hole in the center thereof; a fourth permanent magnet mounted on the other side of the partition and having a hole in the center thereof; a first ball inserted in the hole of the fourth permanent magnet and moving back and forth to turn the fuel into particulates; a sleeve mounted on the other side of the partition and having a hole for passing the fuel in the center thereof; a second ball inserted in the hole for passing the fuel of the sleeve and moving back and forth by magnetic force of the fourth permanent magnet, to turn the fuel into particulates; a cap mounted on one side of the sleeve and having a hole for passing the fuel in the center thereof and a plurality of fuel supply holes in its periphery to supply the fuel to a combustion chamber when the hole for passing the fuel of the sleeve is opened by stepping on an accelerator; a first diffusion fan mounted in the inlet housing to diffuse the fuel; and a second diffusion fan mounted in the outlet housing to further diffuse the fuel.

2. A device as claimed in claim 1, wherein each of the first and the second diffusion fans comprises a plurality of diffusion wings formed in the shape of propellers.

3. A device as claimed in claim 2, wherein the diffusion wings of the first and the second diffusion fans are respectively connected to the inner walls of the inlet housing and the outlet housing.

4. A device as claimed in claim 1, wherein the first ball of metallic material inserted in the hole of the fourth permanent magnet keeps the interval (t) of about 0.05 to 1.0 mm with the hole.
